(19) United States
(12) Patent Application Publication
(10) Pub. No.: US 2006/0286507 A1
(43) Pub. Date: Dec. 21, 2006

(54) Combination set of artificial teeth units for setting-up dentures in balanced articulation

(76) Inventor: Frans Arthur Benoit Dequeker, Burwood (AU)

Correspondence Address: F.A.B., DEQUEKER, P.O. BOX 144, BURWOOD, 1805, N.S.W., 2134, AU

(21) Appl. No.: 11/511,063

(22) Filed: Aug. 28, 2006

Related U.S. Application Data
(63) Continuation-in-part of application No. 10/321,541, filed on Dec. 18, 2002, now abandoned.
(60) Provisional application No. 60/760,695, filed on Jan. 19, 2006.

(51) Int. Cl. A61C 13/00

(52) U.S. Cl. 433/167

(57) ABSTRACT

A combination set (FIG. 1, A,B), at least normalized in a medium size or different sizes and forms, includes complete arched artificial teeth units (1), (2) preformed without denture base, for setting up these units (1), (2) in a denture thereby instantly and adjustable in a full balanced articulation during custom denture work. The set(s) is composed of a complete upper (1) and separate complementary complete lower (2) arched artificial teeth unit, each including anterior and posterior artificial teeth inter-connected either in a complete (A) or under-extended complete (B) tooth arch at least in an oval form and restricted occluso-gingival height. Each of the units includes a total unitary inter-occlusal bite plane preformed in a corresponding centric occlusion and full balanced articulation.

In order to prevent setting up as regularly denture teeth, one by one in the centric and full balanced articulation, hereto the unitary inter-occlusal bite plane is pre-formed according to interconnected styled artificial anterior and posterior teeth. Thereby the bite plane is formed cuspless sphero-ellipsoidal, conforming a 4 inch (11 cm.) radius, thereby to be set on an oblique planar sphero-ellipsoidal bite occlusal level including a free centric inter-occlusal contact (FIG. 2) either full (C,5) or partly (D,6) and a free eccentric bi-lateral balanced articular contact. Having the last molar posterior artificial teeth either broader or not than regularly and pre-formed without tongue interference to ascertain individually the balanced articular contact. Further the set(s) is non-bendable from a durable tooth aesthetic material.

The present invention relates generally to the U.S. patent application Ser. No. 10/321,541, filing date Dec. 18, 2002, and is a continuation in part of it.

More particularly it is related to an election of one of the inventions I, II, III involved in the initial U.S. patent application Ser. No. 10/321,541, and which has been classified as Invention I drawn to a combination sets complete arched artificial teeth units claimed by Claims 1-8 and 31.

### FIELD

Further it is a type of combination set(s) arched artificial teeth units specially suitable for setting up productively teeth with ease and almost instantly in a non-interfering bi-lateral and protrusive balance articulation for a custom denture

### BACKGROUND

For such activity of setting-up teeth of a denture with a conventional complete set(s) of separate individual denture teeth or units thereof, these teeth are often used from a dental supply stock. During practising of said specialized articulation, this is not always satisfactory, as it is recognized that in this instance the setting up is neither productive nor accurate by using the regular available sets of denture teeth or units.

The difficulty arises by setting up the separate denture teeth one by one in individual balance. In this instance there is a risk involved of loss of the position of these teeth due to the use of a bulk of dental wax heated and melted to attach the set-up denture teeth on a base, substantially either of dental wax or plastic conformed to it's respective endentulous jaw model, upper or lower.

During the hardening stage of the wax from hot to cold shrinkage occurs which leads to loss of occlusal balance form during the setting up of the teeth guided with a occlusal balance plate used for such balance setting-up.

Also a movement of the denture teeth relative to each other occurs during check-up of the balance by executing protrusive and bi-lateral excursions with the use of a balance dental articulator used for such set-ups, consequently the balanced articulation is distorted.

To readapt the articulation in balance fit again, by prying in the bulk of wax as in regular use, the same problem repeats as heretofore described. Or to readapt, by the regular technique of over excessive spot grinding, as known, using dental articulating paper and handpiece power tool either in the laboratory or in the mouth, is causing damage to the functional predesignated balance design form of the denture teeth.

For instance, denture teeth according to the doctrine of Beresin-Beresin and the free centric and eccentric Centrimatic denture teeth and other types of denture teeth are characterizing a predesignated balanced design form, and would be damaged.

Previous attempts to provide sets of preformed fully or partly arched denture teeth units to produce a specialized, balanced articulation for custom denture work have had some disadvantages, and were not intended and able to resolve the outstanding problems of the background of present invention.

As the description goes on the difference of idea between the cited attempts and the present invention will be distinctly indicated during the further description of the present invention.

### THE OBJECTIVES OF THIS INVENTION

The general objective is based to avoid the difficulties arising in the background when setting up denture teeth in order to attain a productive and accurate result for a almost instantly full balanced non-interfering articulation for customized denture work.

A primary objective is to provide a preformed combination set(s) of full balanced artificial teeth, united in arched units without denture base, and at least in one normalized size that can be modified in other sizes, or in a variety of three suitable sizes to comply with the different human jaw relations.

A second objective is to provide a preformed combination set(s) artificial teeth units to enable a single skilled trained dental technician, thereby with the only assistance of an apprentice dental technician, to control simultaneously at all times and to produce the non-interfering full balanced articulation for custom denture work. As well as to enable the technician to execute the specialized dental balanced articulation without to be involved in the expenditure for high skilled team work of several high qualified dental technicians.

### THE GENERAL STATEMENT OR SUMMARY OF THE INVENTION

With the objectives in view, the difficulties of the background as defined are solved by the present invention. Hereto the invention provides a suitable normalized consistent balance design form and construction thereof for a preformed combination set complete arched artificial teeth units. Having the set at least in one normalized size or sizes, of pre-formed full balanced artificial teeth units united in complete arched units without denture base.

Having the set(s) composed substantially of a complete arched upper artificial teethunit including anterior and cuspless sphero-ellipsoidal styled posterior artificial teeth preformed in a bi-lateral and protrusive total unitary occlusal bite plane. Separately a complementary complete arched lower artificial teeth unit including anterior and cuspless sphero-ellipsoidal styled posterior artificial teeth preformed in a total unitary occlusal bite plane conformed in a full balance form-fit with the bite plane of the upper artificial teeth unit. Having the occlusal bite plane of the artificial teeth units respectively as total functional.

Thereby each unit is substantially of a normalized arch form size and restricted occluso-gingival height predetermined either in a fully complete extended (A) or under-extended (B) complete arch-form size, in which the second last molars are excluded from each unit. Further each unit is predetermined with the total unitary center-occlusal bite plane normalized in a maintained non-interfering sphero-ellipsoidal balance design form having the posterior artificial teeth cuspless sphero-ellipsoidal including a self centering centric occlusal and bi-lateral free balance eccentric articular contact, and each of the contacts being either full (5) or in part (6). Further having the total unitary inter-occlusal bite plane sphero-ellipsoidal defined to be articular set non-bendable according to a sphero-ellipsoidal, oblique planar leveled occlusal plane. Further the combination set (A,B), is substantial non-bendable formstable tooth-aesthetical colorfast impact resistant (stress relieving) and durable abrasion-proof.

### DETAILED DESCRIPTION OF THE PRESENT INVENTION

With the objectives in view and with reference to the accompanying drawings one preferred embodiment will now be described.

### BRIEF DESCRIPTION OF THE DRAWINGS

FIG. 1 A, B is a top-plan view of a preformed combination set(s) A, B, either in a complete arch form, A, or in a under-extended complete arch form, B, shown as a separate item, thereby illustrating the corresponding inter-occlusal bite planes (3)(4) of the units in a bi-lateral and protrusive formed balance.

FIG. 2 C,D, is a side (proximal) view of the centric occlusal bite relation in the molar-premolar region of the upper and lower inter-occlusal bite plane of the arched artificial teeth units of FIG. 1, thereby having the centric occlusal bite relation either in a structural form of a full occlusal “surface-to-surface” contact as shown in C, (5), or in a partly occlusal “edge-to-surface” contact, D, (6).

FIG. 3, is a side view of a human jaw complex; thereby characterized with a curved oblique temporo-mandibular joint structure (7) and separately showing the complementary curved condyle path movement (8) of this jaw complex showing the jaw complex fitted with a upper 9 and lower 10 denture including the combination set 1,2 designed with a flat planar inter-occlusal bite plane, causing a separation indicated by the mark (<) FIG. 3 of the inter-occlusal bite plane, (3)(4), consequently having a loss of fit and balanced articulation of the upper and lower artificial teeth units of the set of a custom denture (1),(2) in the mouth.

FIG. 4, E,F is a cross-sectional side view of the anterior section, E, of the upper artificial teeth unit of FIG. 1.A, on the line a-a, showing the layering structure of the ceramic-composite material 18 used as the material of choice for the combination set(s) artificial teeth units of FIG. 1, A,B; thereby a cross-sectional side view of the posterior section F, of the upper artificial teeth unit of FIG. 1. A, on the line b-b, showing the layering structure of the ceramic-composite material, 18.

FIG. 5, G,H, is a cross-sectional view on the line a-a of the unit 1, FIG. 1, A/B including a regular custom denture base, G, of thin acrylic plastics, which includes a metallic reinforcement (11)(12) substantially of 2-3 twisted wires, of titanium or super alloyed steel, about 1.2 mm. Ø or substantially of a grid bar 1.5 mm. thick located either in the labial, or in the palatal region or in both of the denture base; in case of an immediate custom denture base, H, the base includes said metallic reinforcements (11)(12) as an indirect extra reinforcement in the alveolar ridge region and in the palatal region when applied to an immediate custom denture.

In an initial aspect of the present invention, there is provided a functional balance design-form for a preformed combination set of complete arched artificial teeth units, upper and lower without denture base. Thereby having the set substantially at least in a medium size and restricted occluso-gingival height or in a variety of sizes related to the human jaw complex relation.

With the objectives in view and use of the set(s), the invention aims, to render a capability for an almost instant, at least non-bendable adjustable and accurate setting-up of the artificial teeth units in a non-interfering, consistent full balance articulation during complete and partial bi-lateral upper and lower free-end custom denture work. By the phrase ‘full balance articulation’ what is meant: total individual maintained consistent balance during a bilateral movement and a combined protrusive movement of the lower jaw, during the custom denture work and oral use.

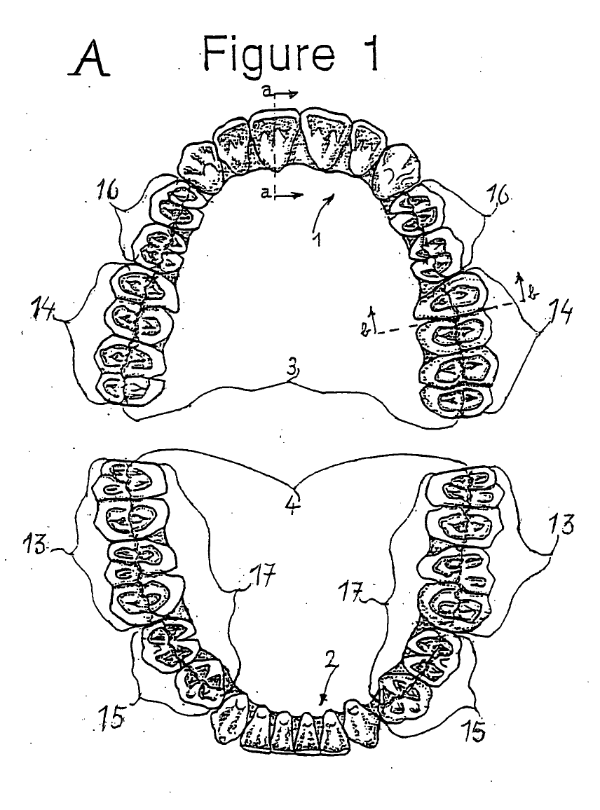

As disclosed in FIG. 1, A, B, the set(s) is preformed in a composition of a complete upper artificial teeth unit (1), indicated by an arrow, and in a composition of a complementary complete lower artificial teeth unit (2), indicated by an arrow, and each unit being in an arch-form about 12 mm maximum said occluso-gingival height, thereby occlusaly conformed to a normalized radius of a sphere including al least 4 inch (11 cm)

As one example, the upper artificial teeth unit (1) includes united anterior artificial teeth and united cuspless sphero-ellipsoidal posterior artificial teeth preformed in a centric occlusal relation and in a bi-lateral and protrusive balanced unitary occlusal bite plane (3). Thereby the lower artificial teeth unit (2) includes united anterior artificial teeth and united cuspless sphero-ellipsoidal posterior artificial teeth preformed in a total unitary occlusal bite plane (4) conformed in a centric and balance form-fit in accordance with the occlusal bite plane (3) of the upper artificial teeth unit.

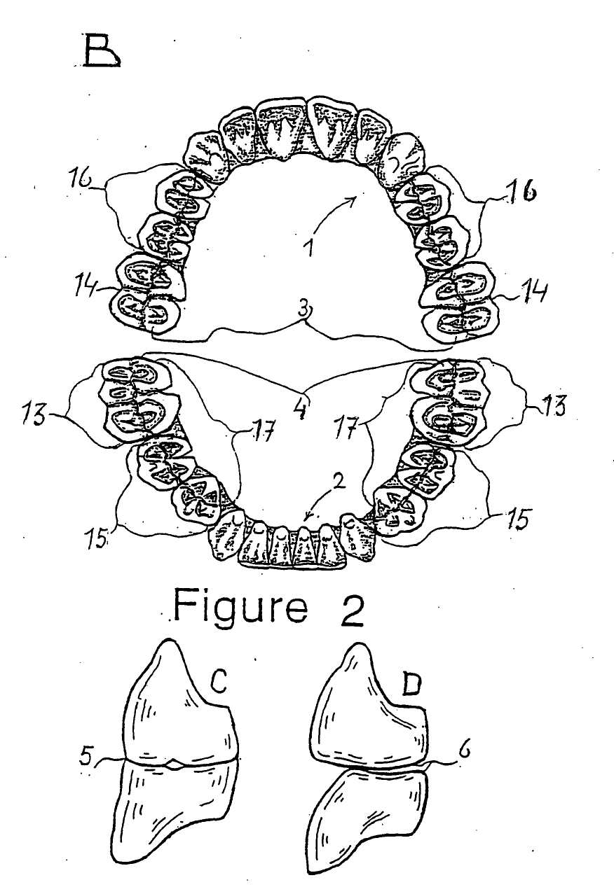

As disclosed in FIG. 1 A,B, having each respective one of the total unitary occlusal bite planes (3) and (4) of the artificial teeth units (1), (2), as a total inter-occlusal bite plane, being articular set oblique planar sphero-ellipsoidal. Thereby FIG. 2 having the inter-occlusal bite plane including either a full C, (5) or in part D, (6) free centric inter-occlusal bite contact and a free eccentric partly balanced articular bite contact, not shown. As further disclosed in FIG. 1, A, B, the molar regions (13), (13) of the occlusal bite plane of the lower artificial teeth unit (2) and the molar regions (14), (14) of the occlusal bite plane of the upper artificial teeth unit (1), these regions may be broader in design form, although predetermined without tongue interference, than the lower (15), (15) and upper (16), (16) premolar regions of the set(s) of present units as shown, and predetermined broader without tongue interference than the molar and pre-molar regions of a conventional complete set of upper and lower denture teeth. It is contemplated that at least one or both artificial teeth units (1), (2) are applicable to above molar principle.

In a case the inter-occlusal bite plane of the posterior artificial teeth is in a design-form ‘edge-to-surface’, as a partly inter-occlusal contact, FIG. 2, (6)D, and as specified in accordance with the Centrimatic articulation doctrine and with the Australian Pat. No AU-B1474/95 (Addition to the Main AU-B642892), in these instances either the upper molar region (14)(14) or the lower molar region (13)(13) is applicable to the broader molar.

The broader design form of the inter-occlusal bite plane (3), (4) of the molars (13),(13) and (14),(14) is another element of present invention to ascertain the consistent maintained stability of the bi-lateral balance articulation during the eccentric articular total inter-occlusal balance bite contact, as specified heretofore in the description, when executed on a human jaw complex characterizing a flailing or extra larger temporo-mandibular joint structure, and articular function thereof.

As disclosed further in FIG. 1, A, B there is shown at the left and right lingual sites (17) (17) of the molar-(13)(13) premolar-(15)(15) regions of the lower artificial unit (2) that the continuous lingual design-form of these sites is based on the principle to comply with the known “Pound's” dental rule by having the lingual aspect of the regions out of the vicinity of the tongue in order to avoid lift-up of a lower denture due to interference of the tongue when the full lower denture is in use.

Further it is recognised in dental practice, that the posterior region of the alveolar ridge of the human jaw complex is characterized with a course either in a regular or in an irregular level. Having this level included of anatomical land marks, such as steep inclines located either anterior to the left and right retromolar pad of the lower jaw, or anterior to the left and right tuberosity pad of the upper jaw.

These landmarks as described are impeding the setting-up of the units (1)(2), firstly in order to establish the inter-occlusal bite plane (3)(4) in centric occlusion; secondly to execute almost instantly the full balanced articulation, as pursued, with the provision and use of the units (1), (2), as predetermined in the initial aspect of present invention, characterizing an occluso-gingival height of 12 mm. and extra molar width as specified heretofore.

In these instances in order to achieve easily the specific full instant balanced articulation of present invention, the arch form of the combination set(s) is predetermined either in a complete extended tooth arch size as disclosed in FIG. 1, A, or in a normalized under-extended complete tooth arch size, as disclosed in FIG. 1, B, whereby the last left and right posterior artificial tooth, in terms and function as second molars, are excluded from each unit

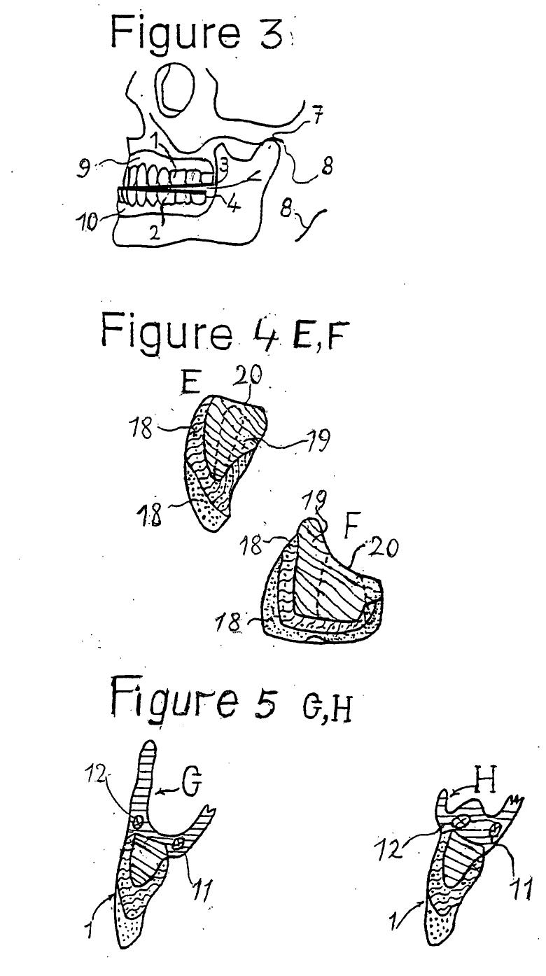

The specific full balanced articulation, as aimed, predetermined and defined initially in the invention, is achieved with the use of the artificial teeth units (1), (2), pre-designed with the occlusal-gingival height about 12 mm. and preferably with the extra molar width without tongue interference as defined heretofore, and with the difference of tooth arch form extension A, B, FIG. 1 of the combination set(s) artificial teeth units. In these instances, the difference related to the tooth arch form size A, B, and height of each respective one of the units (1), (2), is pursued:
i) on the one hand to enable an individual fit of the units (1), (2) whereby their base is respectively conformed in fit on a stable upper (9) and lower (10) said base, as disclosed in FIG. 3 and used as a total bite block base, to set up each respective one of the units.
ii) on the other hand to enable to establish the total unitary occlusal-bite plane (3), of the upper unit (1) and the total unitary-occlusal bite-plane (4) of the lower unit (2) in a mutual corresponding total unitary inter-occlusal free centric occlusion and meanwhile in a free eccentric instant and adjustable full balanced articulation; thereby
having the articulation set on a planar sphero-ellipsoidal oblique occlusal plane in a degree, dependable of the heretofore defined individual path of movement (8) of the temporo-mandibular joint (7) of the human jaw FIG. 3;
in case of the predetermined normalized planar spero-ellipsoidal oblique occlusal level, having this level at least conformed to a 4 inch (11 cm.) radius of a sphere.

Note: The applicant is aware that prior art attempts have been made either to use full arched denture teeth units, such as related to the invention U.S. Pat. No. 2,768,440 or to use sectional units (posterior and anterior) related to the invention U.S. Pat. No. 4,437,0421, and all, in order to set up denture teeth in a regular centric occlusion. However these attempts were without consideration for a full instant non-interfering consistent balanced articulation for custom denture work. Thereby these attempts were practising a technique of bending the units in place, either by heat or by moving denture teeth, mounted on a flexible plastic strip or wire, in a desired position relative to each other with the purpose to conform the denture teeth units in articulation on a plaster jaw model complex. This technique as heretofore, was not possible in most individual cases to establish an instant maintained full balanced planar (evenly leveled) sphero-ellipsoidal oblique articulation. While the regular conventional technique, including modifying the shape of the units by over excessive grinding, was causing to make the units weak, and loss of the essential design form.

In these instances it was not previously recognised that attributes of the kind of arch design form of present invention made it particularly useful for other dental techniques such as to create an instant and minimum adjustable non-interfering maintained full balanced articulation with the use of preformed full arched artificial teeth units (1), (2) and executed with an appropriate setting-up procedure.

Also to comply further the setting-up of the combination set(s) (1),(2) A,B individually in the full balanced articulation, as disclosed in the foregoing description, in this instance at least the set might be provided as a standard set in one suitable tooth arch size, such as a medium size, that conforms the most commonly appearing medium arch size of the alveolar ridge of the individual endentulous human jaw complex upper and lower to be restored. Thereby having the standard set(s) further at least in an ovoid arch configuration, in a desired age tooth colour e.g. such as a greyish-yellow shade, and in a tapered shape for the anterior artificial teeth arranged in a natural appearance conforming to the most appearing anterior tooth arrangement in human dentition.

As an exemplification: during the setting-up of the preformed standard medium size combination set(s) artificial teeth as defined heretofore, this set(s) might be altered in a smaller, or larger size, which might be the case. Having the units which are in use, further separated in three sections, including a section of the united anterior teeth, and a left and right section of the united posterior artificial teeth, thereby to be set up in accordance with an appropriate setting up procedure.

Further for instance, in a case where the standard set is transformed in a smaller size:—
the units (1), (2), of the set B, FIG. 1 are divided in 3 sections as defined heretofore;
thereby the first premolar, of the left and right posterior tooth section of each unit, is either removed or not;
the separated sections are further set-up in the balance articulation using an appropriate setting up procedure; as a cardinal rule:
during transforming in the size of choice, the left and right molar of each unit (1), (2) when using the standard set B, FIG. 1, are never removed in order to ascertain consistent bi-lateral balance in accordance with the individual joint structure of the jaw complex, which may have an irregular anatomical condition and function thereof.

It might be further contemplated to provide the combination set(s) (1) (2), A,B, FIG. 1, preformed in a variety of standard sizes such as: small, medium, large with the aim:

(i) at the one hand, having the variety combination sets of standard tooth arch sizes as an alternative provision readily to use any suitable desired size set units (1), (2) that enables to set readily the units instantly and adjustable in the full balanced articulation instead of previous technique using the standard combination set predetermined in one medium tooth arch size;

(ii)—at the other hand, having the variety combination sets of standard tooth arch sizes as an alternative provision to comply the setting-ups of artificial teeth units (1), (2) individually in full balanced articulation adaptable to the situation of a variety of jaw sizes and bite relations occurring in nature and classified according to 3 different classes of jaw relations I, II, III;
hereto using a technique of combining and relating the units (1), (2) with each other of the combination sets including a variety of standard tooth arch sizes;
thereby in case of need to conform the jaw ridge form, further segmenting of the units is applied according to the proposed technique of previous standard medium tooth arch size;
further setting up the desired size by use of an appropriate setting-up procedure for present invention.

In that concern of the foregoing provision of the variety combination sets complete arched artificial teeth units, while the setting-up techniques of the cited prior art inventions of arched tooth units are using their denture teeth units in a variety of standard sizes only with the idea to conform the setting-up more or less readily with the different sizes of jaw existing in nature, such as small, medium and large.

In this instance it was not recognized that attributes of the kind of the provision, as the present disclosed variety tooth arch sizes, for the combination sets artificial teeth units, made it particularly useful for other dental techniques, such as to create an instant, accurate and adjustable non-interfering consistent maintained full balance articulation with the use of the sets in the variety of sizes and without bending. Thereby having the set(s) preformed in a balanced articulation to accommodate the situation of jaw relations in nature classified according to classes of different jaw relations I, II, III.

As heretofore disclosed in the total description, the combination complete set(s), FIG. 1, (1),(2), A,B, artificial teeth units are preformed substantially of a durable abrasion-, form-bend-, and color-proof aesthetic tooth material such as dental ceramic or a derivative thereof substantially as a suitable light or dual light-self curable composite dental material, 18 combined (or not) with a self-curable hard rigid ethyl-meth-acrylic resin 19 designed for bonding strength and impact resistance stress relieving, of the units, (1),(2) when used to the final denture base of acrylic denture work.

Referring to FIG. 4 E,F, these two united tooth materials 18+19 are chemical and physical different based resinuous materials. Having one resinuous material 18 chemically based on a resinuous light or dual light-self curable Bis G.M.A. dimethacrylate including or not an addition of appropriate chemically binding mineral fillers thereby substantially in a physical supra-structural form of a durable restorable abrasion-proof complete arched unitary hollow tooth crown/structure in one piece 18+18. Having the other resinous material 19 united with this initial tooth crown/structure of resinuous material 18+18 and based chemically of a self-curable rigid hard ethyl-methacrylate 19 substantially of physical substructural form of an impact resistant stress relieved complete arched unitary solid reduced tooth crown/structure on one piece of 19+20.

Besides each tooth arch form size is at least in an oval configuration, in one color most common in nature related to a desired human age, e.g. such as greyish-yellow. Further preformed with posterior and anterior styled artificial teeth in one arch form piece. Having the anterior artificial teeth characterized with an outer tooth anatomy at least in one natural tapered form, preferably trapezoid, which may be adjusted into an oval or square, or triangle, or combined form.

Thereof, either of the ceramic tooth materials include the capability to be formed with a predetermined mechanical retentive shape as a durable joining aid to be applied to denture base materials of various plastics during custom denture work.

In the case of using the light curable ceramic-composite material 18, combined with said self-curable ethyl-methacrylate 19 and formed partly as the unitary ridge lap base of the combination set(s) denture teeth, as disclosed in FIG. 4, E, F (20), in this instance the combined materials include the capability to be formed with a durable chemical bonding interface and tooth color conservation and impact resistance to the set (1),(2), FIG. 1, A, B, when used to denture base materials of acrylic plastics and other during custom denture work.

It will be appreciated to note that the combination set(s) FIG. 1, A,B, is substantially appropriate of setting-up the combination set(s) upper and lower units, 1, 2, in an almost instant, minor adjustable and full (bi-lateral and protrusive) balanced articulation during custom denture work including a complete (upper and lower) either regular- or over-denture or a complete implant either regular- or over-denture or a partial (upper and lower) bi-lateral free-end denture.
In view of the general objective, indeed there is a need for a provision of an improved functionally designed preformed normalized combination set(s) complete arched artificial teeth units (A,B) in a predetermined normalized design form for setting up at least a complete custom denture in an easy, non-bendable and instant manner to establish a non-interfering consistent maintained balance articulation in the dental laboratory as well as during oral use, thereby with a minimum of expenditure of equipment, labor and time.

While the invention has been illustrated in present description and drawing, the same is to be considered as illustrative and not restricted in character.

Thereby it being understood that only the preferred embodiment has been shown and described and that all changes, further drawings and modifications that come within the meaning of the intended invention may be desired to be included for protection.

What I claim:

1. A combination set of preformed complete upper and lower dentures, without denture base, including upper and correspondingly lower artificial teeth united in an upper and lower arch respectively being non-bendable form stable and substantially formed from a durable, abrasion proof color fast aesthetic tooth material for use in setting up custom dentures in an almost instant non-interfering self-centering fully balanced articulation, each of the dentures include a total unitary inter-occlusal bite plane preferably in a mutual centric occlusion; having the combination set featurized that is essential; each denture is predetermined substantially of an upper and lower arch form each normalized in a restricted, occluso-gingival height and preferably normalized in an oval configuration; besides normalized in a fully extended as well as under-extended complete arch form excluded from the second last molars; besides each denture is predetermined substantially of a total unitary inter-occlusal bite plane substantially normalized including at least one predetermined spherical radius applied to the total unitary sphero-ellipsoidal inter-occlusal bite plane substantially and functionally of unitary sphero-ellipsoidal (incising) anterior artificial teeth and unitary cuspless sphero-ellipsoidal (masticating) posterior artificial teeth allowing to set-up said balanced articulation for an instant and maintained fully balanced form fit including either a full or partly occlusal contact; besides having the total unitary inter-occlusal sphero-ellipsoidal bite plane being articular set in an oblique planar (leveled) sphero ellipsoidal bite/occlusal level during the articulation set-up.

2. A combination set as claimed in claim 1, in which the posterior artificial teeth of the set, in terms and function as premolars and molars, are predesignated in a design form including either a regular or irregular buccal-lingual and buccal-palatal width related at least to one left and one right molar of the complete upper and the complete lower artificial teeth unit of the set; whereby the irregular buccal-lingual and the buccal-palatal widths are designed without tongue interference and broader than the buccal-lingual and buccal-palatal width related to the pre-molars of the combination set artificial teeth units; having the irregular buccal-lingual and buccal-palatal width substantially rendering a consistent stabilized bi-lateral individual balance articular contact for the total unitary inter-occlusal bite plane of the units (1)(2) particularly suitable in a condition of a human's temporo-mandibular joint being larger or flailing than usually.

3. A combination set as claimed in claim 1 or 2, in which the centric occlusion and balanced articulation of the preformed articular setting up of the combination set(s) united artificial teeth are respectively in an exact free centric occlusion and non-interfering protrusive and bi-lateral balanced articulation; thereby having the united artificial teeth substantially of anterior and posterior teeth occlusaly conformed to a normalized radius of a sphere including at least 4 inch (11 cm).

4. A combination set as claimed in claim 2, in which the molars of the posterior artificial teeth of the set characterized by the irregular buccal-lingual and buccal-palatal width are formed with the buccal part out of alignment buccalwardly with the contour of the buccal part of the premolars of the posterior artificial teeth of the set, while the lingual part and palatal part of the posterior artificial molar teeth are in a regular alignment with the contour of the lingual and palatal part of the premolars of the posterior artificial teeth of the set.

5. A combination set as claimed in claim 1 or 2, in which the set is either substantially at least normalized in a medium arch size, or in different arch form sizes including large, medium and small; thereby each arch form size is at least in a ½ oval configuration in one color most common in nature related to a middle human age, or in a desired natural tooth color further preformed with anterior and posterior artificial defined teeth at least into a naturally tapered form preferably trapezoid, and in a tooth arrangement most common in nature.

6. A combination set as claimed in claim 5, in which the set of different arch form sizes, when combined with each other are suitable to accommodate individual articular setting-ups for custom dentures in bi-lateral and protrusive full balanced articulation applicable to three different types of upper and lower jaw relations regularly appearing in human jaw complex.

7. A combination set as claimed in claim 1, in which the durable tooth material of the set, is substantial of ceramic or of a light curable or dual light-self curable ceramic composite; having either of the materials, during preforming the set substantially designed and formed with a mechanical retentive shape for a durable hold of the set when applied to denture base materials of the custom dentures.

8. A combination set as claimed in claim 1 or 7, in which the tooth material is substantially of two united different chemically and physically based resinuous materials; having one resinuous materials chemically of a resinuous light or dual light-selfcurable Bis G.M.A dimethacrylate including or not an addition of appropriate chemically binding mineral fillers thereby substantially in a physical supra-structural form of a durable restorable abrasion-proof complete arched unitary hollow tooth crown/structure in one piece; having the other resinuous material united with this initial tooth crown structure resinuous material and based chemically of a self-curable rigid hard ethyl-methacrylate, substantially in a physical substructural form of an impact resistant stress relieved complete arched unitary solid reduced tooth crown structure in one piece.

9. A combination set as claimed in claim 8, in which the set, is substantially of the ceramic composite including the substructial tooth crown structure formed with a unitary ridge lap base of an impact resistant rigid hard ethyl or impact resistant methyl methacrylate rendering a durable chemically bonding retentive shape and stress relieving impact resistance when the set is in combination with denture plastic base materials of customized dentures.

10. A combination set as claimed in claim 1, in which the combination set(s) upper and lower artificial teeth units, preformed in a fully complete or under-extended complete arch form, are substantially appropriate of allowing setting up the combination set(s) artificial teeth in an almost instant, minor adjustable, and full (bi-lateral and protrusive) balanced articulation during custom denture work including either a complete regular or over—(upper and lower) denture or complete implant denture or a complete implant over-denture or a partial (upper and lower) bi-lateral free-end denture,
